(19) United States
(12) Patent Application Publication
(10) Pub. No.: US 2024/0217791 A1
(43) Pub. Date: Jul. 4, 2024

(54) SANITARY FREE-FALL SAFETY DEVICE FOR AUTOMATED LIFTING APPLICATIONS

(71) Applicant: Tri-Mach Group Inc., Elmira (CA)

(72) Inventors: Joshua Bailey, Listowel (CA); Kaedyn Koch Nichol, Atwood (CA); Maximilian Lundershausen, Waterloo (CA)

(21) Appl. No.: 18/394,449

(22) Filed: Dec. 22, 2023

Related U.S. Application Data
(60) Provisional application No. 63/436,975, filed on Jan. 4, 2023.

(51) Int. Cl. B66F 7/28; B66F 7/02

(52) U.S. Cl. CPC B66F 7/28; B66F 7/02

(57) ABSTRACT

A free-fall safety device for installation on a machine assembly having a load includes a base member having a locking member disposed thereon, a lifting member releasably secured to the base member, the lifting member for supporting the load in position on the machine assembly, wherein the base member is rotatable in response to a reduction in tension applied to the lifting member, in order to engage the locking member to lock the base member and lifting member in position on the machine assembly. In one embodiment, rotation of the base member is effected by decompression of a moveable member in response to a change in tension within the lifting member. If the lifting member suffers a sudden catastrophic failure, then tension in the lifting member will be released, which in turn will activate and decompress the moveable member and cause the base member to rotate into a locking position.

### TECHNICAL FIELD

The present disclosure relates to mechanical safety devices for industrial lift applications and in particular to a free-fall safety locking device for use in locking a lifting member in position along a vertical plane.

### BACKGROUND

Multi-level manufacturing assemblies are becoming used more prominently in industry and pose unique challenges. One particular challenge relates to safely overcoming elevation changes in production flow in material handling applications. When the industry requires higher levels of sanitation, the challenges become even more complex.

Typical lifting mechanisms are slow or use components that are not considered appropriate for use in a high sanitation environment. The prior art safety mechanisms that are used in conjunction with these systems are typically only capable of handling slow moving and non-automatic loads. The most common prior art fall safety mechanisms involve the use of brake motors, or mechanical load brakes, for controlling the lowering speeds of lifting members and preventing lifting members from free falling. These mechanisms are in place to counteract the gravitational pull and for facilitating a safe, controlled locking or lowering of the lifting member.

Unfortunately, these mechanisms can be prone to mechanical failure. Some prior art fall safety devices utilize mechanisms that work off of the main drive axle, which will become ineffective in the event of a catastrophic failure of the lifting member.

What is desired is a solution that: (i) can be triggered automatically in the event of lifting member failure; (ii) facilitates efficient sanitization (without material degradation); (iii) and can handle the loading of high-speed lifting applications (non-limiting e.g. >120 fpm).

### BRIEF DESCRIPTION OF THE DRAWINGS

Various aspects of at least one example embodiment of the present invention are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure.

In the drawings:

FIG. 1 is a perspective view of a sanitary free-fall safety device installed on a machine assembly in accordance with one embodiment of the present invention.

FIG. 2 is a front elevation view of the device of FIG. 1.

FIG. 3 is an alternative perspective view of the device of FIG. 1 in an unlocked configuration.

FIG. 4 is a front elevation view of the device of FIG. 3.

FIG. 5 is a perspective view of the device of FIG. 1 in a locked configuration.

FIG. 6 is an alternative perspective view of the device of FIG. 1.

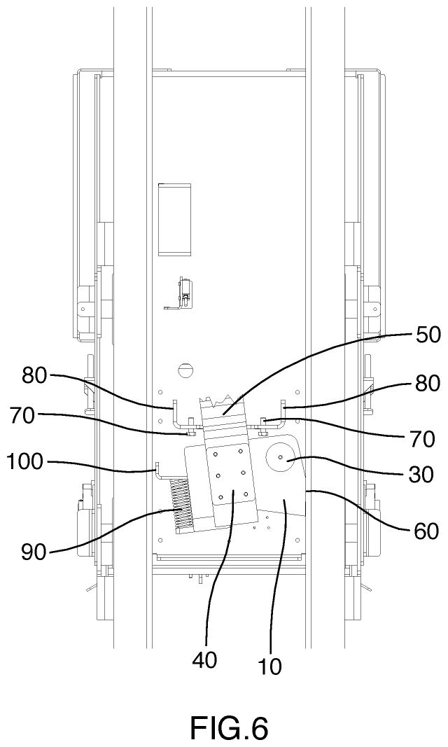

FIG. 7 is an alternative front elevation view of the device of FIG. 5, with certain parts omitted for clarity.

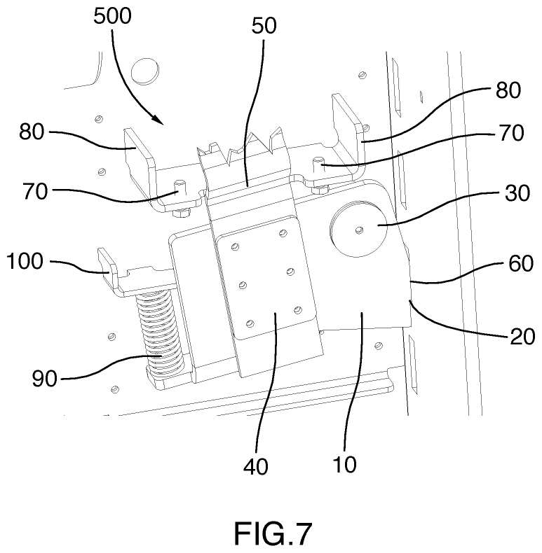

FIG. 8 is a front elevation view of the device of FIG. 6, with certain parts omitted for clarity.

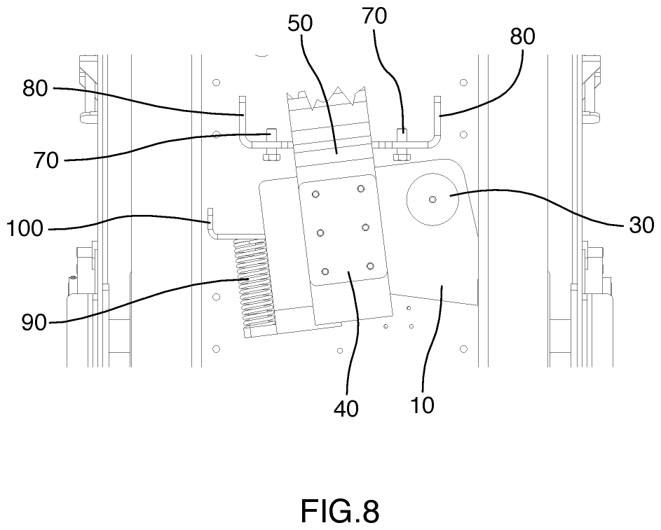

### DETAILED DESCRIPTION OF PARTICULAR EMBODIMENTS

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways.

Also, it is to be understood that the phraseology and terminology employed herein are for the purpose of description and should not be regarded as limiting. In particular, all terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, the stated features and/or configurations or embodiments thereof the suggested intent may be applied as seen fit to certain operating conditions or environments by one experienced in the field of art.

References in the specification to “one embodiment”, “an embodiment”, “a preferred embodiment”, “an alternative embodiment”, “embodiments”, “variations”, “a variation” and similar phrases mean that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation.

The term “couple”, “coupled”, “connected”, “joined”, “attached” or “fixed” as used in this specification and the appended claims refers to either an indirect or direct connection between the identified elements, components or objects. Often the manner of the coupling will be related specifically to the manner in which the two coupled elements interact.

As used herein, “substantially” means sufficient to work for the intended purpose. As used herein, the terms “substantially” and “approximately” allow for minor, insignificant variations from an absolute or perfect state, dimension, measurement, result, or the like such as would be expected by a person of ordinary skill in the field, but that do not appreciably affect overall performance. When used with respect to numerical values, ratios, or parameters or characteristics that can be expressed as numerical values, the terms “substantially” and “approximately” mean within twenty percent (20%).

As indicated above, a novel and inventive free-fall safety device for use in automated lifting applications, which overcomes noted prior art deficiencies, is desired. As described herein, the free-fall safety device of the present disclosure is engineered to be triggered automatically in the event of lifting member failure. In addition, the device is designed to facilitate easy cleaning and/or sterilization—this is particularly important in certain manufacturing applications, including but not limited to applications in the food manufacturing space. Further, the device of the present disclosure is capable of handling loading in high-speed lifting applications (e.g. applications which lowering speeds of greater than 120 fpm).

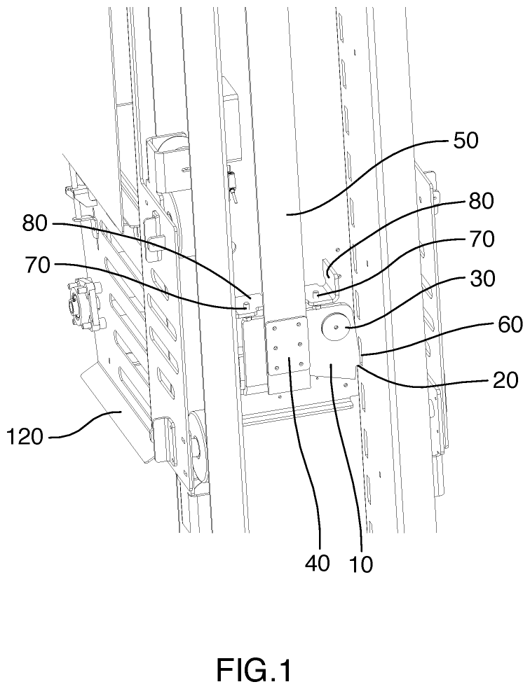

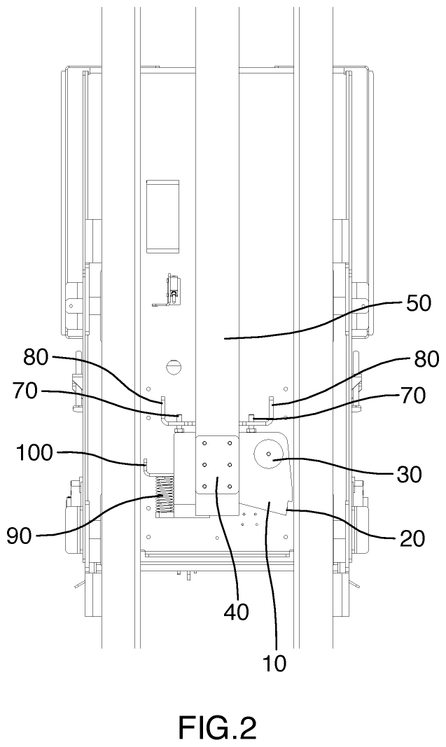

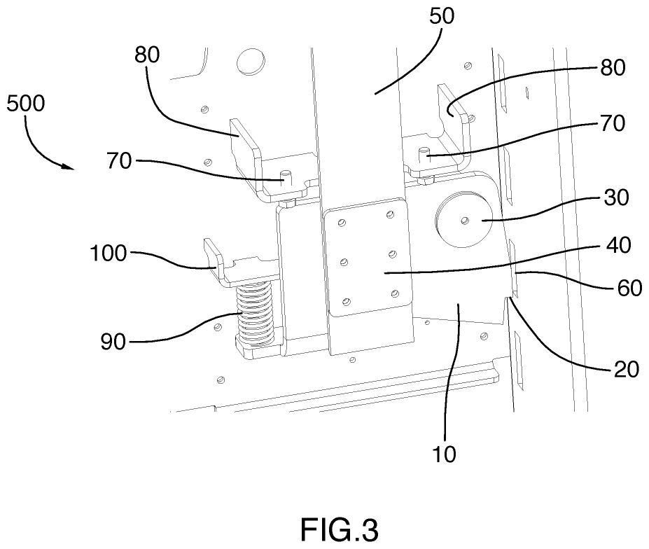

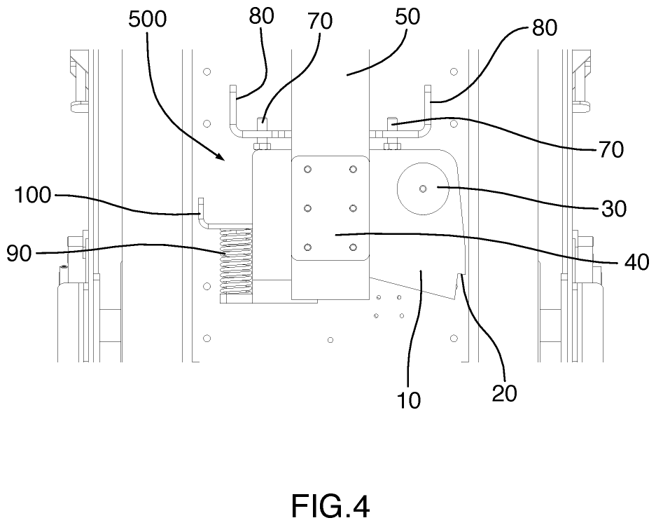

Referring first to FIGS. 1 and 2, there is shown a sanitary free-fall safety device installed on a machine assembly in accordance with one embodiment of the present invention. Close-up images of the device 500 are shown in FIGS. 3 and 4. Importantly, the machine assembly on which the device of the present invention is installed do not form part of the inventive subject matter.

Referring to FIGS. 1-5, there is shown a device 500, which incorporates a lift system, including a base member 10. A lifting member 50 is releasably secured to the base member 10 via a securement member 40. The base member 10 is itself rotatably connected to the machine assembly itself such that the base member 10 is capable of rotating around a horizontal axis in response to variations in tension applied to the lifting member 50. The base member 10 has an at least one locking member 20 disposed thereon, the locking member 20 for interacting with a complementary engagement member 60 disposed on the machine assembly. The base member 10 also includes a pivot member 30 that the base member 10 rotates around. In one embodiment, the base member 10 takes the form of a plate having an at least one locking member 20 disposed thereon for facilitating securement of the base member 10 to the machine assembly in response to rotational forces applied to the base member 10.

The securement member 40 is shown in the drawings as a plate through which the lifting member 50 attaches to the base member 10. The securement member 40 can take other forms (e.g. an adhesive connection between the lifting member 50 and the base member 10; tying or bolting the lifting member 50 directly to the base member 10; or other suitable means).

In one embodiment, the pivot member 30 of the base member 10 is not medially disposed on the base member 10. Rather, the pivot member 30 may be positioned away from a medial position on the base member 10 and in close proximity to the at least one locking member 20 and/or on the same side of the base member 10 as the locking member 20.

In one embodiment, the pivot member 30 of the base member 10 is disposed on the same side of the base member 10 as the at least one locking member 20 relative to the lifting member 50. In the embodiments shown in the drawings, the pivot member 30 is an off-centre pivot, meaning that the pivot point is not located in the centre of the base member 10.

In one embodiment, the pivot member 30 is a pivot point, which permits rotation of the base member 10 relative to the machine assembly, where the base member 10 is pivotally (or rotatably) connected to the machine assembly via the pivot point. In one embodiment, the pivot member 30 comprises a body member (shown as a cylindrical body member in the drawings) having an aperture for receiving a rod or shaft (or other similar apparatus) for pivotally (or rotatably) connecting the base member 10 to the machine assembly, where the rod or shaft is pivotally (or rotatably) connected to both the base member 10 and the machine assembly. In one embodiment, the pivot member 30 is a shaft hole (or aperture) formed through the front end of the base member 10 through which the base member 10 can be rotatably connected to the machine assembly.

Also disposed in operative engagement with the base member 10 is a moveable member 90, which is configured to move in a particular direction in response to a force exerted by movement of the lifting member 50, where the moveable member 90 is positioned relative to the base member 10 such that the moveable member 90 is operatively engaged via movement of the lifting member 50. In one embodiment, the moveable member 90 is disposed on the base member 10. In another embodiment, the moveable member is connected to the base member 10.

In one embodiment, the moveable member 90 and the at least one locking member 20 are disposed on opposite sides of the base member 10, with the lifting member 50 positioned therebetween.

In one embodiment, the moveable member 90 takes the form of a loaded spring 90 which is operatively connected to a first member 100. The spring 90 is capable of being decompressed in response to a change in tension applied by the movement of the lifting member 50 (i.e. a loss of tension), where the decompression is caused by a downward (or substantially downward) force applied to the base member 10. In one embodiment, the first member 100 is fixed in position on the machine assembly. In one embodiment, the first member 100 includes an abutment for aiding in releasably securing the spring to the first member. In addition, in one embodiment, the opposite end of the spring is also releasably secured to the base member 10 via an abutment disposed on the base member. In each case, the spring wraps around each abutment (on each of the first member 100 and the base member 10) in order to prevent the spring 90 from sliding out of engagement with the device on application of the appropriate directional force applied to the spring.

In one embodiment, in a resting position, the moveable member 90 applies an upward force upon the first member 100 and applies a downward force upon the base member 10, in the vicinity of the moveable member's 90 area of contact with the base member 10, and the moveable member 90 is held in position in the device by the tension in the lifting member 50.

In one embodiment, the moveable member 90 is a resilient energy storage member which is held in its ready (or resting) state by tension applied by the lifting member 50. In one particular embodiment, as previously described, the moveable member 90 is a loaded spring operatively engaged with the lifting member 50, where the spring 90 is capable of being decompressed in response to a change in tension applied by the movement of the lifting member 50.

In one embodiment, the moveable member 90 is operatively connected to the base member 10 such that compression or decompression of the moveable member 90 will cause rotation of the base member 10 along a vertical plane within the machine assembly.

In one embodiment, the lifting member 50 is a lifting belt which is tensioned in response to movement of the lifted load 120 to which the lifting belt 50 is attached. In the machine assembly embodiments shown in the drawings, the lifted load 120 is a conveyor, however, the device of the present invention could be installed on a machine assembly which includes any form of mass being acted upon by gravity. For example, the lifting member 50 could take the form of a chain, cable, rope, strap or other suitable product or material.

In one embodiment, the lifting member 50 is releasably secured to the base member 10. In one embodiment, the base member 10 is rotatably connected to the machine assembly itself such that the base member 10 is capable of rotating around a horizontal axis in response to variations in tension applied to the lifting member 50.

In one embodiment, the at least one locking member 20 of the base member 10 interacts with an at least one cooperative locking member 60 directly or indirectly secured to the machine assembly to catch and lock the lifted load 120 in position after failure of the lifting member 50. In one embodiment, the at least one locking member 20 takes the form of an at least one tooth or flange portion (or equivalent) disposed on an elongated bar, which is capable of interacting with an at least one aperture 60 or indentation (or equivalent) in a locking arrangement. This locking arrangement prevents rotation of the base member 10 in response to even minor changes in tension within the lifting member 50. Other suitable mechanical locking arrangements could be employed, such as male-female connecting arrangements, friction locking members, teeth and pawl mechanisms, and the like.

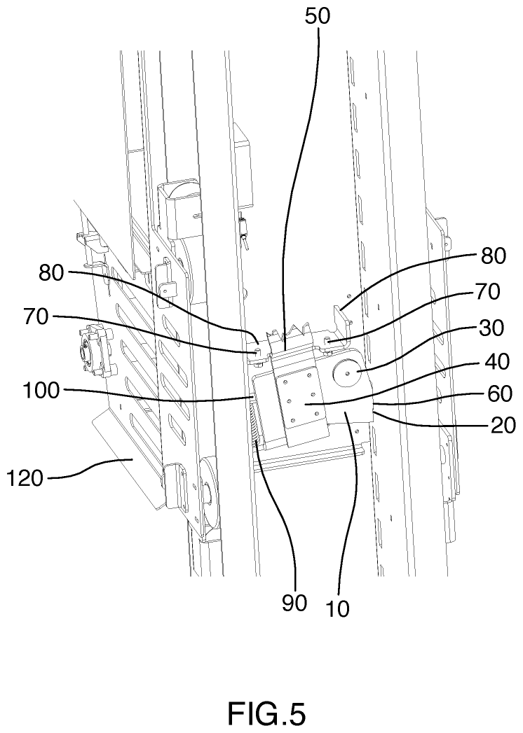

The functioning principle of the device of the present invention is that the moveable member 90 is decompressed by a change in tension within the lifting member 50. For example, if the lifting member 50 suffers a sudden catastrophic failure (e.g. free fall), then tension in the lifting member 50 will be released, which in turn will activate and decompress the moveable member 90. Decompression of the moveable member 90 will release stored energy in the moveable member 90, and cause the base member 10 to rotate in response. In one embodiment, the base member 10 will rotate in response to decompression of the moveable member 90, which will in turn cause the at least one locking member 20 of the base member 10 to move into engagement with the machine assembly, thereby locking the lifting member 50 in place and preventing free fall of the lifted load 120 to which the lifting member 50 is attached. For further clarity, contrast FIG. 3 with FIG. 5, where FIG. 3 shows the device in an unlocked configuration and FIG. 5 shows the device in a locked configuration.

In one embodiment, as previously described herein, the moveable member 90 is a spring and decompression of the spring causes the freefall prevention mechanism to engage by rotation of the base member 10 into a locking arrangement with the machine assembly.

The device of the present invention is designed to interfere with features in a lifting tower of the machine assembly. When interference occurs, freefall is arrested saving both equipment and potentially operators in the vicinity of the machine assembly.

In one embodiment, lifting force is allayed via use of an at least one securement member 80. In the drawings, a pair of securement members are shown, however, one continuous securement member 80 could also be employed. The securement members 80 help to displace load upon the pivot member 30, thereby reducing wear on the device and permitting reliable operation of the device. By reducing the reaction force in the joint (i.e. at the pivot member 30), sanitary materials with lower yield strength can be utilized. Each at least one securement member 80 includes an adjustment member 70. In the drawings, the adjustment members 70 are shown as bolts disposed on either side of the lifting member 50 in the vicinity of the base member 10 which can be raised up or down relative to the at least one securement member 80 by turning the bolts clockwise or counterclockwise. While bolts are shown in the drawings, the at least one adjustment member 70 can include any positive locating means that shoulders the direct load from the lifting mechanism of the machine assembly, thereby saving the pivot member 30 from excessive wear. When the bolts are adjusted properly on the at least one securement member 80, the bolts make equal contact with an upper surface of the base member 10. In one embodiment, the at least one securement member 80 and the at least one adjustment member 70 are one and the same, such that the at least one securement member may itself be adjusted relative to the position of the base member 10. In another embodiment, the position of the securement member 80 may be stationary and the position of the base member 10 may be adjustable such that the upper surface of the base member 10 (or a portion thereof) can be moved into contact with the securement member 80 (or a portion thereof). In another embodiment, there a two adjustment members disposed on the securement member 80 for contacting an upper surface of the base member. In one embodiment, there is one adjustment member 70 disposed on either side of the lifting member 50. In this embodiment, the adjustment members 70 may be disposed equidistant from the sides of the lifting member in order to ensure equal force distribution of the base member 10 (via its pivot point). In one embodiment, there is a single adjustment member 70 which is disposed medially on the securement member and which contacts the base member 10 at (or in the vicinity of) the medial section (or midline) of the lifting member.

The at least one securement member 80 is fixedly attached to the machine assembly such that the at least one securement member 80 (or the at least one adjustment member 70 thereon). Proper adjustment of the at least one adjustment member relative to the base member 10 permits the full force of the load to be transferred through the mechanism without applying undue force upon the pivot member 30. Application of undue force upon the pivot member 30 could lead to deformation of the pivot member 30 and/or base member 10 and prevent the base member 10 from rotating when the lifting member 50 fails.

Owing to the efficiency of its design, the device of the present invention can be readily sanitized without the need to apply material effort. Sanitization of manufacturing equipment, including multi-level manufacturing assemblies, is important. In particular, in food manufacturing applications, regulatory and safety requirements necessitate regular sanitization of manufacturing equipment. In one embodiment, the device of the present invention has an operating position and a maintenance position. Thorough and efficient sanitization is achieved by lowering the device to a maintenance position wherein the lifting member 50 is disconnected from the base member 10, such that the components of the device become readily accessible for sanitization purposes.

In one embodiment, lowering the device to a maintenance position permits the load 120 to sit on hard stops as the lifting member 50 is lowered, thereby relieving the tension in the lifting member (or belt) 50. In one embodiment, in a maintenance position, the at least one cooperative locking member 60 can also be removed (or repositioned) in order to permit the base member 10 to pivot further without locking into a fixed position. In a maintenance position, since the load has already been safely lowered, there is no use locking the base member 10. Allowing for a greater angle of rotation of the base member 10 facilitates easy and efficient sanitization of the device. The moveable member 90 can then be removed for sanitation, and the base member 10 can also be disconnected from its pivot member 30.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any modification, combination or permutation of any of the components, elements, functions, operations, or steps described or illustrated anywhere herein that a person having ordinary skill in the art would comprehend. All such modifications, combinations and permutations are believed to be within the sphere and scope of the invention as defined by the claims appended hereto.

We claim:

1. A free-fall safety device for installation on a machine assembly having a load, the device comprising:
A base member having a locking member disposed thereon;
A lifting member releasably secured to the base member, the lifting member for supporting the load in position on the machine assembly;
wherein the base member is rotatable in response to a reduction in tension applied to the lifting member, in order to engage the locking member to lock the base member and lifting member in position on the machine assembly.

2. The device of claim 1 further comprising a moveable member operatively connected to the base member and the lifting member, such that force exerted by movement of the lifting member causes decompression of the moveable member, which in turn causes the base member to rotate into a locked position on the machine assembly.

3. The device of claim 3, wherein the moveable member is a spring.

4. The device of claim 4, wherein the spring has a first member operatively connected to the spring where the first member is positioned to contact the spring and receive an upward force applied by the spring in its resting position.

5. The device of claim 1 wherein the lifting member is a belt.

6. The device of claim 1 wherein the locking member comprises a first locking member and a cooperative locking member, wherein the first locking member and the cooperative locking member are capable of engaging together in response to rotation of the base member, in order to lock the lifting member in position on the machine assembly.

7. The device of claim 1 wherein the cooperative locking member is connected to the machine assembly and disposed substantially adjacent to the base member.

8. The device of claim 1 further comprising a securement member for releasably securing the base member to the lifting member.

9. The device of claim 1 wherein rotation of the base member is achieved by use of a pivot member disposed on the base member, wherein the base member rotates around the pivot member.

10. The device of claim 9 wherein the pivot member is not medially disposed on the base member.

11. The device of claim 9 wherein the pivot member is disposed on the same side of the base member as the at least one locking member relative to the lifting member.

12. The device of claim 9 wherein the pivot member is a pivot point which permits rotation of the base member relative to the machine assembly, where the base member rotatably connected to the machine assembly via the pivot point.

13. The device of claim 2 wherein the moveable member and the locking member are disposed on opposite sides of the base member, with the lifting member positioned therebetween.

14. The device of claim 2 wherein the moveable member is a resilient energy storage member which is held in its resting state by tension applied by the lifting member, wherein decompression of the moveable member will release stored energy in the resilient energy storage member, and cause the base member to rotate into a locked position.

15. The device of claim 9 further comprising an at least one securement member, the at least one securement member positioned on the machine assembly such that the at least one securement member contacts a portion of an upper surface of the base member in order to help displace load upon the pivot member.
